(19) United States
(12) Patent Application Publication
(10) Pub. No.: US 2022/0322832 A1
(43) Pub. Date: Oct. 13, 2022

(54) TENSIONING STRAP, IN PARTICULAR FOR A SYSTEM FOR SUPPORTING A HUMAN BODY OR A HUMAN BODY SEGMENT

(71) Applicant: PRO MEDICARE S.R.L., (US)

(72) Inventor: Rosaria Eugenia CAFORIO, MESAGNE (BR) (IT)

(21) Appl. No.: 17/642,693

(22) PCT Filed: Sep. 16, 2020
(86) PCT No.: PCT/IB2020/058607

§ 371 Date: Mar. 13, 2022

(30) Foreign Application Priority Data
Sep. 17, 2019 (IT) 102019000016544

(51) Int. Cl. A47C 7/42; A47C 7/46

(52) U.S. Cl. CPC A47C 7/42; A47C 7/46

(57) ABSTRACT

A tensioning strap, the stiffness of which can be varied in a wide range of values, is provided. The tensioning strap comprises a base body, made as a strip of flexible material, and one or more stiffening elements applied to the base body. The stiffening elements can be applied to the base body in a permanent, non-removable manner, or, in a removable manner. In this way, the stiffening elements can be applied, removed, displaced, replaced with stiffening elements of different types depending on the needs. The tensioning strap finds particular, though non-exclusive, application in the making of a system of tensioning straps for a system for supporting a human body or a segment thereof.

### TECHNICAL FIELD

The present invention relates to a tensioning strap.

More particularly, the present invention relates to a tensioning strap for a system for supporting a human body or a human body segment.

### BACKGROUND ART

Tensioning straps are known and widely used in many fields.

By way of non-limiting example, tensioning straps are used as stiffening elements for conferring stiffness to a support system, such as a seat, a backrest, a stretcher or the like, for the human body or a segment thereof.

Tensioning straps are usually mounted between a pair of support uprights arranged at the sides of the system for supporting the human body and have an adjustable length, so that they can be tensioned by reducing their length and they can be released by increasing their length.

In this way, they can be brought to the desired tension in order to provide the correct stiffness of the system for supporting the human body.

The tensioning straps that are known and commonly used, however, are not free from drawbacks and limitations.

In particular, adjusting the length of said tensioning straps is basically the sole degree of freedom to vary the stiffness provided by the tensioning straps, which places an important constraint on the achievable range of stiffnesses.

The main object of the present invention is to overcome this limitation by providing a tensioning strap in which the possibility of varying the stiffness of the strap is significantly increased compared to known tensioning straps.

These and other objects are achieved by a tensioning strap as claimed in the appended claims.

### SUMMARY OF INVENTION

The tensioning strap according to the invention comprises a base body, made as a strip made of a flexible material, and one or more stiffening elements applied to said base body at respective application regions.

In the case where the strip of flexible material forming the base body of the tensioning strap has a given and substantially constant width, the stiffening elements have a width substantially equal to or smaller than the width of said strap, so that the overall dimensions of the tensioning strap are not substantially altered by the presence of said stiffening elements.

In the case where the strip of flexible material forming the base body of the tensioning strap has a variable width, the stiffening elements have a width substantially equal to or smaller than the width of said strap at the respective application region, so that the overall dimensions of the tensioning strap are not substantially altered by the presence of said stiffening elements.

In general, the tensioning strap comprises a middle portion, adapted to be arranged between a pair of uprights or similar support elements, and a pair of end portions, each of which is adapted to be folded in a ring-like manner around a corresponding upright.

Said one or more stiffening elements are preferably applied to the base body of the tensioning strap at its middle portion.

In a first possible embodiment of the invention, the stiffening elements are applied to the base body of the tensioning strap in a permanent, non-removable manner.

According to this embodiment of the invention, during the manufacturing step it is possible to manufacture a single model of the base body of the tensioning strap, and subsequently apply different stiffening elements according to the specific applications for which the tensioning straps are intended.

It is therefore clear that the invention makes it possible to obtain a plurality of tensioning straps with different characteristics of stiffness with a particularly simple production process and considerable cost saving.

In a second, preferred embodiment of the invention, the stiffening elements are applied to the base body of the tensioning strap in a removable manner.

According to this embodiment of the invention, said stiffening elements can be applied, removed, displaced, replaced with stiffening elements of different types depending on the needs.

It is therefore clear that, according to this particular embodiment of the invention, not only does the invention allow obtaining tensioning straps having a large variety of different stiffnesses, but it also allows to vary this stiffness over time, if necessary or appropriate.

The present invention further relates to a system for supporting a human body or a human body segment, said system comprising at least a pair of fixed support elements (for example, a pair of support uprights) and one or more tensioning straps according to the invention arranged between said support elements and connected thereto.

### BRIEF DESCRIPTION OF DRAWINGS

Further features and advantages of the invention will become apparent from the ensuing description of a preferred embodiment of the invention, given by way of non-limiting example, with reference to the annexed drawings, in which:

FIG. 1 shows a plurality of tensioning straps according to the invention.

FIG. 2 shows an example of application of the tensioning straps of FIG. 1 to a system for supporting the human body or a segment thereof, more particularly to a backrest.

### DESCRIPTION OF EMBODIMENTS

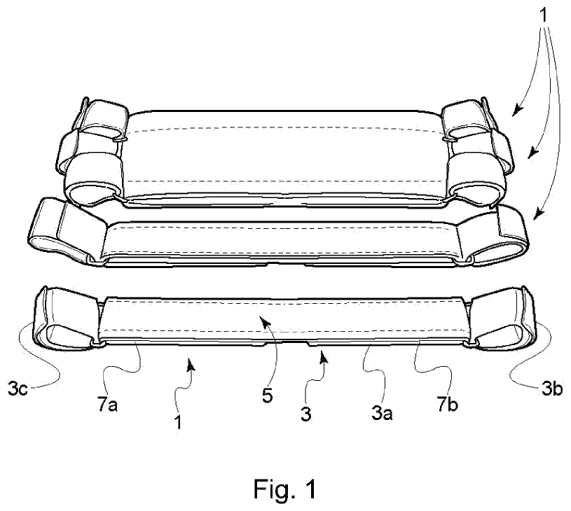

Referring to the FIG. 1 annexed hereto, there are illustrated tensioning straps 1 according to the invention.

In a manner known per se, each of said tensioning straps 1 comprises a base body 3, made as a strip made of a flexible material. For example, said base body 3 can be made of a synthetic textile material, such as nylon.

The base body 3 comprises a middle portion 3a, which in use is adapted to be arranged between a pair of fixed support elements (such as, for example, a pair of support uprights), and a pair of end portions 3b, 3c, each of which is adapted to be folded over itself in order to form a ring around a corresponding fixed support element.

Again in a manner known per se, the length of the base body 3 of the tensioning strap 1 is adjustable, so that it can be selectively reduced, so that it tensions the strap and provides stiffness thereto, or selectively increased, so that the tension of the strap is released.

According to the invention, the tensioning strap 1 comprises one or more stiffening elements 5 applied to the base body 3 at respective application regions.

In the illustrated embodiment, the strip of flexible material forming the base body 3 of the tensioning strap 1 has a substantially given constant length, and the stiffening elements 5 have a width substantially equal to or lower than the width of said strip, so that the overall dimensions of the tensioning strap are not substantially altered by the presence of said stiffening elements.

In the case where the strip of flexible material forming the base body 3 of the tensioning strap 1 had a variable width, the stiffening elements 5 would have a width substantially equal to or smaller than the width of said strap at the respective application region, so that the overall dimensions of the tensioning strap would not be altered.

Preferably, said one or more stiffening elements 5 are applied to the middle portion 3a of the base body 3 (i.e. the application region(s) of the stiffening elements is/are located in the middle portion of the base body, or coincide(s) therewith).

In the example illustrated in FIG. 1, there is provided only one stiffening element 5.

Alternatively, several stiffening elements may be provided, aligned along the direction of the longitudinal axis of said base body 3 and/or arranged parallel to said axis of said base body.

Advantageously, the present of said stiffening elements offers—besides the ability to adjust the length of the base body of the tensioning strap—a further parameter for varying the stiffness that can be provided by said tensioning strap.

In a possible embodiment of the invention, the stiffening elements are applied to the base body of the tensioning strap in a permanent, non-removable manner.

For example, said stiffening elements are applied to said base body by means of stitching or by means of an adhesive.

In the preferred embodiment shown in FIG. 1, instead, the stiffening elements 5 are applied to the base body 3 of the tensioning strap 1 in a removable manner.

For example, as can be seen in FIG. 1, the base body 3 and the stiffening element 5 can be provided with hook-and-loop strips 7a, 7b, of the male and female type, respectively, cooperating with each other, such as, for example, strips made of Velcro™ or similar materials.

Alternatively, the base body 3 and the stiffening elements 5 could be mutually coupled in a removable manner by means of snap-button system.

Furthermore, the base body 3 could be equipped with one or more pockets, adapted to accommodate the respective stiffening elements 5.

More generally, any technique known to the person skilled in the art for the removable coupling of the stiffening elements to the base body can be used.

Advantageously, thanks to the fact that the stiffening elements 5 are removably coupled to the base body 3, they can be applied, removed, displaced and/or replaced with stiffening elements having different characteristics (in particular, a different stiffness) depending on the needs of the specific application.

It should be noted that, thanks to the fact that the stiffening elements 5 have a width substantially equal to, or smaller than the width of the strip made of flexible material forming the base body 3 of the tensioning strap 1 (at least at the corresponding application region), they can be coupled to said base body in a firm and accurate manner. This will be made possible, in particular, by suitably dimensioning and positioning the hook-and-loop strips 7a, 7b, or similar coupling means employed. This will also be ensured when the stiffening elements are received in pockets formed in the base body 3.

Accordingly, the resulting stiffness of the tensioning strap can be accurately determined and selected as required.

In addition to providing stiffening elements 5 with different interchangeable stiffnesses, it is also possible to advantageously provide for the tensioning strap 5 to be equipped with a number of different interchangeable stiffening elements 5 with different shapes and contours.

This will introduce new degrees of freedom in the ability to adjust the stiffness of the tensioning strap 5.

Consequently, the stiffness of the tensioning strap 1 can also be modified over time, if necessary or appropriate.

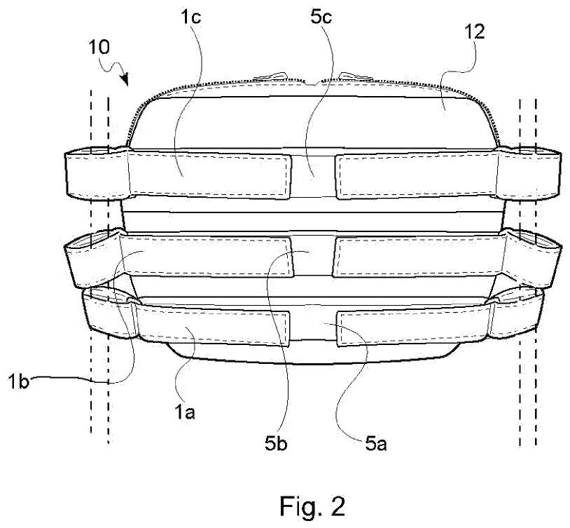

By way of non-limiting example, FIG. 2 shows a possible application of the invention to a system for supporting a human body, or a human body segment, said system comprising at least a pair of fixed supports; in this application, a plurality of tensioning straps according to the invention can be used for providing stiffness to said support system by arranging said tensioning straps between said pair of fixed supports.

For example, tensioning straps according to the invention can be used for providing stiffness to a backrest 10 comprising a pair of uprights (schematically indicated by dashed lines) and a padded cushion 12.

A plurality of tensioning straps according to the invention can be arranged above one another between the uprights in order to provide stiffness to the padded cushion.

Advantageously, thanks to the invention, such stiffness can be modified not only by adjusting the length of the tensioning straps, but also by applying specific stiffening elements to the base bodies of said tensioning straps.

In particular, stiffening elements 5a, 5b, 5c with different properties can be applied to different tensioning straps 1a, 1b, 1c, depending on their position, in order to provide differentiated stiffness along the vertical extension of the backrest.

It is clear that the application to systems for supporting a human body, or one of its segments, is not to be understood in a limiting sense, and tensioning straps according to the invention can find application in many fields.

It is also evident that the embodiment described above has been given merely by way of example and that numerous modifications and variations are possible without leaving the scope of protection of the invention, as defined by the appended claims.

1. A tensioning strap, comprising a base body, made as a strip of flexible material, and one or more stiffening elements which are applied to the base body at respective application regions, wherein the strip of flexible material has a width and each of the one or more stiffening elements has a width which is equal to or smaller than the width of the strip of flexible material at the respective application region.

2. The tensioning strap according to claim 1, wherein the strip of flexible material has a constant width, and wherein the stiffening elements have a width which is substantially equal to the constant width of the strip of flexible material.

3. The tensioning strap according to claim 1, wherein the stiffening elements are applied to the base body in a permanent, non-removable manner.

4. The tensioning strap according to claim 3, wherein the stiffening elements are applied to the base body by sewing or by means of an adhesive.

5. The tensioning strap according to claim 1, wherein the stiffening elements are applied to the base body in a removable manner.

6. (canceled)

7. The tensioning strap according to claim 5, wherein the base body and the stiffening elements are provided with hook-and-loop strips, of the male and female type, respectively, cooperating with each other.

8. The tensioning strap according to claim 5, wherein the base body is provided with one or more pockets, suitable for receiving respective stiffening elements.

9. The tensioning strap according to claim 1, wherein a single stiffening element is applied to the base body.

10. The tensioning strap according to claim 1, wherein several stiffening elements are applied to the base body, wherein the strip of flexible material forming the base body has a longitudinal axis, and wherein the stiffening elements are aligned along the longitudinal axis of the base body.

11. The tensioning strap according to claim 1, wherein the base body comprises a middle portion and a pair of end portions, wherein each of the end portions is folded over itself to form a ring, and wherein the one or more stiffening elements are applied to the middle portion of the base body.

12. The tensioning strap according to claim 1, wherein several stiffening elements with different stiffnesses are provided.

13. The tensioning strap according claim 1, wherein several stiffening elements with different shapes and contours are provided.

14. A support system for supporting a human body or a human body segment, wherein the support system comprising at least a pair of fixed support elements, wherein the support system further comprises one or more tensioning straps arranged between the pair of support elements and connected to the pair of support elements, wherein each of the tensioning straps comprises a base body, made as a strip of flexible material, and one or more stiffening elements which are applied to the base body at respective application regions, wherein the strip of flexible material has a width and each of the one or more stiffening elements has a width which is equal to or smaller than the width of the strip of flexible material at the respective application region.

15. The support system according to claim 14, wherein the base body of each of the one or more tensioning straps comprises a middle portion and a pair of end portions, wherein each of the end portions is folded over itself to form a ring around a respective support element of the support system, and wherein the one or more stiffening elements are applied to the middle portion of the base body.

16. The support system according to claim 14, wherein the support system is a backrest, wherein the pair of support elements is a pair of uprights of the backrest, and wherein the backrest further comprises a padded cushion arranged between the uprights.

17. The tensioning strap according to claim 13, wherein the stiffening elements with different shapes and contours are interchangeable with one another.

18. The tensioning strap according to claim 12, wherein the stiffening elements with different stiffnesses are interchangeable with one another.

19. The tensioning strap according to claim 1, wherein several stiffening elements are applied to the base body, wherein the strip of flexible material forming the base body has a longitudinal axis, and wherein the stiffening elements are arranged parallel to the longitudinal axis of the base body.
